(19) United States
(12) Patent Application Publication
(10) Pub. No.: US 2008/0197220 A1
(43) Pub. Date: Aug. 21, 2008

(54) Automatic paging paper shredder

(76) Inventor: Tony Tsai, Shanghai (CN)

Correspondence Address: ZHEN ZHENG LU, 1730 HUNTINGTON DRIVE #304, DUARTE, CA, 91010, US

(21) Appl. No.: 12/029,839

(22) Filed: Feb. 12, 2008

(30) Foreign Application Priority Data
Jan. 6, 2007 (CN) 200710041585.1

(51) Int. Cl. B02C 18/22

(52) U.S. Cl. 241/34

(57) ABSTRACT

An automatic paging paper shredder includes a cover provided at a top of the paper shredder, a paper supporting frame inclinedly extending to an underside of the cover, forming a paper entry channel between the paper supporting frame and the cover, wherein the paper entry channel having a bottom part that is narrower than an upper part of the paper entry channel, a master capstan provided on a middle part of the paper entry channel, a driving unit for driving the master capstan, and a knife shaft having a blade provided under the paper entry channel for shredding paper.

### BACKGROUND OF THE PRESENT INVENTION

1. Field of Invention

The present invention relates to a paper shredder, and more particularly to a paper shredder that can automatically page, so as to shred paper in large quantities.

2. Description of Related Arts

The paper shredder is a kind of commonly used equipment for shredding paper which is useless. Due to its convenience, the paper shredder has become a kind of necessary office stationery. However, the present paper shredder can only process limit papers at one time. If too many papers are processed at one time, the paper may be stuck in the paper shredder, which may damage the paper shredder in serious condition. Therefore, when a large quantity of papers are needed to be shredded, the paper should be put into the paper shredder as a batch manually, which cost time and labor.

### SUMMARY OF THE PRESENT INVENTION

A main object of the present invention is to provide a paper shredder that can automatically page, so as to shred paper in large quantities.

Accordingly, in order to accomplish the above object, the present invention provides automatic paging paper shredder, which comprises a cover provided at a top of the paper shredder, a paper supporting frame inclinedly extending to an underside of the cover, forming a paper entry channel between the paper supporting frame and the cover, wherein the paper entry channel having a bottom part that is narrower than an upper part of the paper entry channel, a master capstan provided on a middle part of the paper entry channel, a driving unit for driving the master capstan, and a knife shaft having a blade provided under the paper entry channel for shredding paper.

The automatic paging paper shredder further comprises a pressure block provided at a bottom part of the paper supporting frame, having an upper end pivotally mounted on the cover, and a lower end disposed at the bottom channel.

A resilient element is provided at a back of the pressure block, pushing the pressure block towards the paper supporting frame.

The automatic paging paper shredder further comprises a secondary capstan provided on the paper supporting frame at the bottom channel.

The automatic paging paper shredder further comprises a pressure plate has an upper end pivotally mounted on the cover, and hangs downwardly extending to a middle part of the automatic paper entry channel.

The cover has a manual paper entry channel provided on the knife shaft.

The master capstan has a friction enhancing layer at a circumference thereof.

The secondary capstan has a friction enhancing layer at a circumference thereof.

The automatic paging paper shredder further comprises an inching switch provided at the automatic paper entry channel.

The automatic paging paper shredder further comprises an inching switch provided at the manual paper entry channel.

When shredding a large quantity of papers, put the paper on the paper supporting frame. The master capstan at the bottom channel of the cover can automatically page the papers, so that the papers can be shredded as a batch, which saves time and labor. And in this manner, the paper is not easily stuck.

These and other objectives, features, and advantages of the present invention will become apparent from the following detailed description, the accompanying drawings, and the appended claims.

### BRIEF DESCRIPTION OF THE DRAWINGS

FIG. 1 is a sectional view of an automatic paging paper shredder of the first embodiment according to a preferred embodiment of the present invention.

FIG. 2 is a partially enlarged view of FIG. 1.

FIG. 3 is a sectional view of an automatic paging paper shredder of the second embodiment according to the above preferred embodiment of the present invention.

FIG. 4 is a partially enlarged view of FIG. 3.

FIG. 5 is an illustrative view of FIG. 3 when the cover of the paper shredder is open.

### DETAILED DESCRIPTION OF THE PREFERRED EMBODIMENT

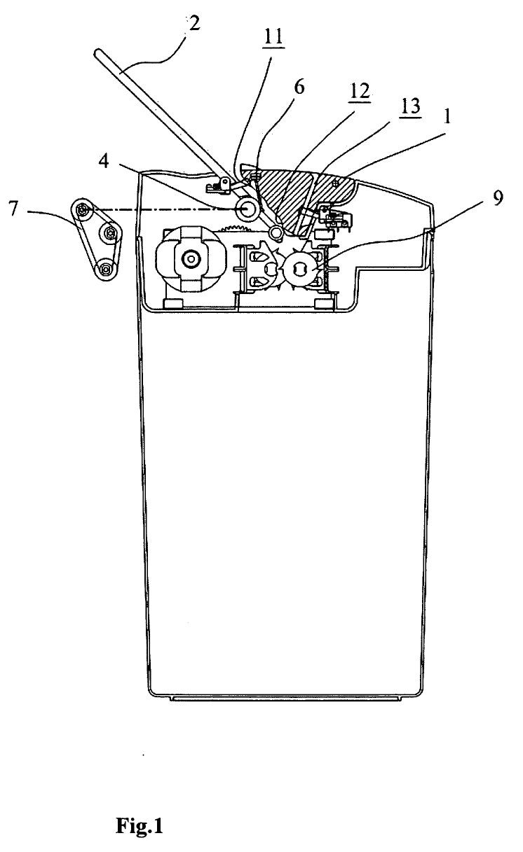

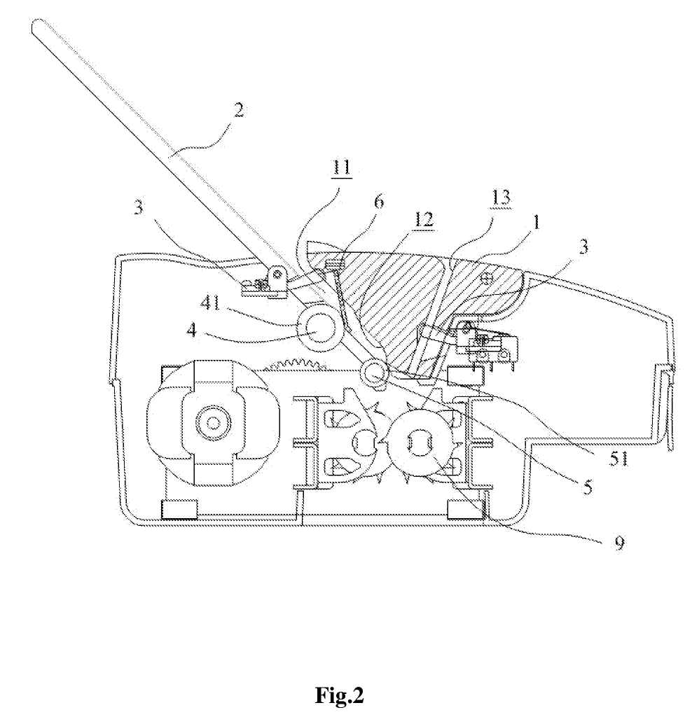

Referring to FIGS. 1 and 2 of the drawings, an automatic paging paper shredder of the first embodiment according to a preferred embodiment of the present invention is illustrated. The automatic paging paper shredder has an opening at a top thereof corresponding to the shredding knife shaft 9. A cover 1 and a paper supporting frame 2 are provided at the opening. The paper supporting frame 2 is inclinedly extending to an underside of the cover 1, forming a paper entry channel 11 between the paper supporting frame 2 and the cover 1. The cover near the bottom of the paper supporting frame 2 is closed to the paper supporting frame 2, so that the paper entry channel 11 is become narrower at the bottom of the paper supporting frame 2, forming a bottom channel 12. The bottom channel 12 is preferably an arch-shaped.

A master capstan 4 is provided on the paper supporting frame 2 at a middle portion of the automatic paper entry channel 11. The master capstan 4 is driven by a driving unit coupled with a motor for driving the shredding knife shaft, or driven by a driving unit 7 solely. An inching switch 3 is provided in the automatic paper entry channel 11. When the paper enters into the paper entry channel, a touching arm of the inching switch 3 is pressed down, so as to actuate the motor or the sole driving unit 7 to rotate the master capstan 4. A friction enhancing layer 41 is provided at the circumference of the master capstan 4, so as to increasing a friction when paper entering into the paper entry channel. The friction enhancing layer 41 is made of rubber or the like materials. The master capstan 4 can transmit the paper on the paper supporting frame downwardly, when rotating. A secondary capstan 5 is provided on the paper supporting frame at the bottom channel 12, and a friction enhancing layer 51 is provided at the circumference of the secondary capstan 5. When the paper entering into the paper entry channel, the paper passes through a gap between the bottom channel 12 of the cover 1 and the secondary capstan 5, and is shredded by a blade of the knife shaft 9 below the gap.

A pressure plate 6 has an upper end pivotally mounted on the cover 1, and hangs downwardly extending to a middle portion of the automatic paper entry channel 11. The pressure plate 6 has a lower end leaning against the master capstan 4, such that when receiving paper, the pressure plate 6 is pushed up firstly, and hangs down with gravity so as to press the paper tightly.

During usage, papers are put on the paper supporting frame 2 and into the automatic paper entry channel 11. Then the master capstan 4 rotates for transmit paper downwardly. Because the automatic paper entry channel 11 is wider at upper portion, and narrower at lower portion, and the gap between the bottom channel 12 of the cover 1 and the secondary capstan 5 is small, only a part of papers on the bottom of the all papers can pass through the gap, according to the size of the gap and the thickness of the paper. After this part of papers pass through the gap, another part of papers on the bottom of the rest of papers can pass through the gap, and then all papers can pass through the paper entry channel 11 as a batch and are shredded by the blade of the knife shaft 9.

As shown in FIGS. 1 and 2, the cover 1 further has a manual paper entry channel 13. When an operator needs to shred a CD or a thick paper, the manual paper entry channel 13 should be used. An inching switch 3 is also provided in the manual paper entry channel 13. When the paper enters into the paper entry channel, the inching switch 3 is triggered to rotate the knife shaft 9 to shred paper.

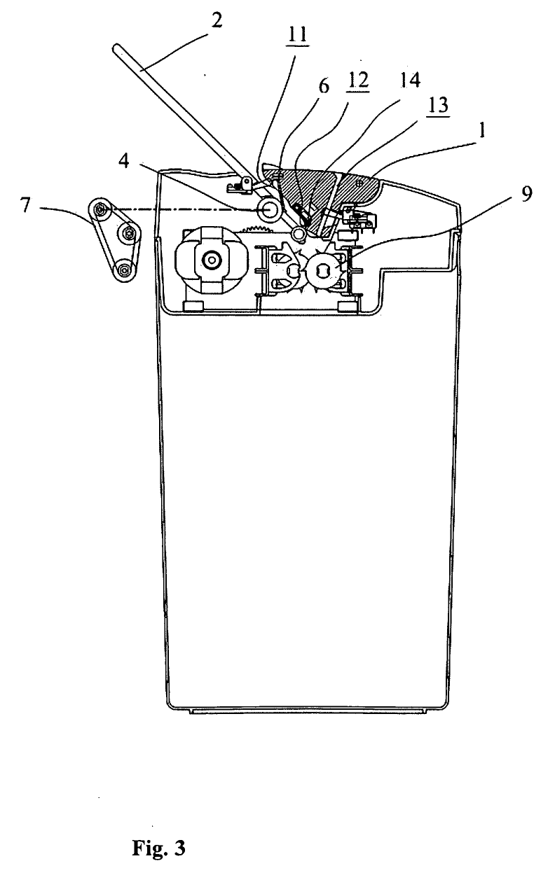

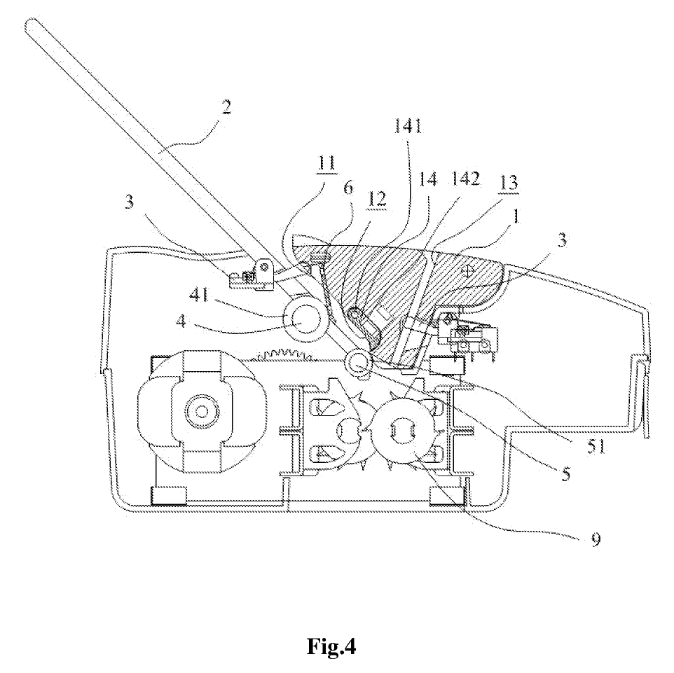

Referring to FIGS. 3 and 4 of the drawings, according to the second embodiment of the present invention, a pressure block 14 is provided on the cover 1 closed to the bottom of the paper supporting frame 2. The pressure block 14 has an upper portion pivotally mounted on the cover 1 via a pin 141, and the bottom channel 12 is formed at a lower portion of the pressure block 14. The bottom channel 12 is preferably an arch-shaped. A resilient element 142 is provided at a back of the pressure block 14 to push the pressure block 14 toward the paper supporting frame 2, forming a small gap between the bottom channel 12 and the secondary capstan 5. The paper is pressed tightly when passing through the gap, so as to be guided to pass through the automatic paper entry channel 11.

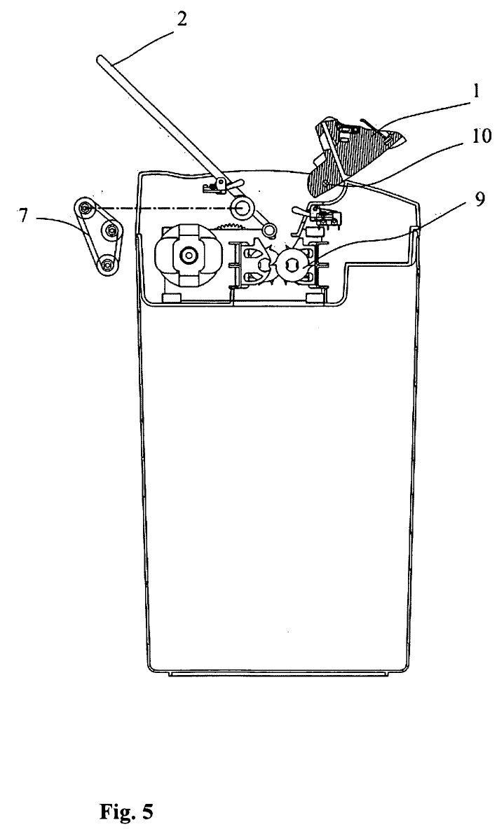

Referring to FIG. 5 of the drawings, the cover 1 is pivotally mounted on the opening via a shaft 10, so that the cover can turn up, which is very useful, when the paper is stuck, or when the paper shredder needs checking or maintaining inside.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1. An automatic paging paper shredder, comprising:
a cover provided at a top of said paper shredder;
a paper supporting frame inclinedly extending to an underside of said cover, forming a paper entry channel between said paper supporting frame and said cover, wherein said paper entry channel having a bottom part that is narrower than an upper part of said paper entry channel;
a master capstan provided on a middle part of said paper entry channel;
a driving unit for driving said master capstan; and
a knife shaft having a blade provided under said paper entry channel for shredding paper.

2. The automatic paging paper shredder, as recited in claim 1, further comprising a pressure block provided at a bottom part of said paper supporting frame, having an upper end pivotally mounted on said cover, and a lower end disposed at said bottom channel.

3. The automatic paging paper shredder, as recited in claim 2, wherein a resilient element is provided at a back of said pressure block, pushing said pressure block towards said paper supporting frame.

4. The automatic paging paper shredder, as recited in claim 1, further comprising a secondary capstan provided on said paper supporting frame at said bottom channel.

5-10. (canceled)

11. The automatic paging paper shredder, as recited in claim 2, further comprising a secondary capstan provided on said paper supporting frame at said bottom channel.

12. The automatic paging paper shredder, as recited in claim 3, further comprising a secondary capstan provided on said paper supporting frame at said bottom channel.

13. The automatic paging paper shredder, as recited in claim 1, further comprising a pressure plate has an upper end pivotally mounted on said cover, and hangs downwardly extending to a middle part of said automatic paper entry channel.

14. The automatic paging paper shredder, as recited in claim 2, further comprising a pressure plate has an upper end pivotally mounted on said cover, and hangs downwardly extending to a middle part of said automatic paper entry channel.

15. The automatic paging paper shredder, as recited in claim 3, further comprising a pressure plate has an upper end pivotally mounted on said cover, and hangs downwardly extending to a middle part of said automatic paper entry channel.

16. The automatic paging paper shredder, as recited in claim 1, wherein said cover has a manual paper entry channel provided on said knife shaft.

17. The automatic paging paper shredder, as recited in claim 2, wherein said cover has a manual paper entry channel provided on said knife shaft.

18. The automatic paging paper shredder, as recited in claim 3, wherein said cover has a manual paper entry channel provided on said knife shaft.

19. The automatic paging paper shredder, as recited in claim 1, wherein said master capstan has a friction enhancing layer at a circumference thereof.

20. The automatic paging paper shredder, as recited in claim 2, wherein said master capstan has a friction enhancing layer at a circumference thereof.

21. The automatic paging paper shredder, as recited in claim 3, wherein said master capstan has a friction enhancing layer at a circumference thereof.

22. The automatic paging paper shredder, as recited in claim 4, wherein said secondary capstan has a friction enhancing layer at a circumference thereof.

23. The automatic paging paper shredder, as recited in claim 1, further comprising an inching switch provided at said automatic paper entry channel.

24. The automatic paging paper shredder, as recited in claim 2, further comprising an inching switch provided at said automatic paper entry channel.

25. The automatic paging paper shredder, as recited in claim 3, further comprising an inching switch provided at said automatic paper entry channel.

26. The automatic paging paper shredder, as recited in claim 6, further comprising an inching switch provided at said manual paper entry channel.
